(19) United States
(12) Patent Application Publication
(10) Pub. No.: US 2026/0042114 A1
(43) Pub. Date: Feb. 12, 2026

(54) METHODS AND SYSTEMS FOR COATING FLOSS SEGMENTS OF FLOSSING DEVICES

(71) Applicant: Coda Resources Ltd., Matawan, NJ (US)

(72) Inventor: Moshe Tropper, Lakewood, NJ (US)

(21) Appl. No.: 18/797,954

(22) Filed: Aug. 8, 2024

(51) Int. Cl. B05C 5/02; A61C 15/04

(52) U.S. Cl. CPC B05C 5/0212; A61C 15/046

(57) ABSTRACT

Provided herein is a system for coating a plurality of floss segments attached to a rigid mount, the system including: a frame configured to fixedly arrange the floss segments in an array; and a container configured to fixedly overlay the array, the container including surrounding side walls, a lower membrane, and a coating composition within the container. The lower membrane may have apertures that are configured to align with the floss segments in the array. The apertures may be covered with an encumbrance. The encumbrances may be configured to prevent egress of the coating composition through the apertures at ambient pressure. The system may include a rigid pressure applicator, which may be configured to apply downward pressure horizontally across the lower membrane of the container.

### FIELD OF TECHNOLOGY

Aspects of the disclosure relate to methods and systems for coating a floss segment, in particular when the floss segment is attached to a flossing device.

### BACKGROUND

Flossing devices are known in the art. Such devices may contain a floss segment. The floss segment may be tautly attached to a rigid frame.

The floss segment of a flossing device may be coated, for example with a coating containing a flavored composition including flavoring and wax. Coating typically involves applying the composition to one side of the floss. Coating the floss segment efficiently and reproducibly presents a technical challenge, particularly in a mass-production setting.

It is preferable to avoid coating portions of the flossing device other than the floss segment.

It is also preferable to simultaneously coat a plurality of flossing devices in order to increase factory efficiency. Prior art methods include spraying a coating on floss segments of flossing devices.

### SUMMARY

The present inventors have discovered that mass-production methods for coating floss segments, within a flossing device, do not evenly coat the length of the floss segment. Also, such methods may not evenly distribute a coating among multiple flossing devices when multiple devices are coated simultaneously within an array.

It is an object of this disclosure to improve methods for coating floss segments of a flossing device.

It is a further object of this disclosure to reproducibly apply a coating to floss segments in the context of an array.

It is a further object of this disclosure to reproducibly apply a coating to floss segments in the context of mass production of flossing devices.

An improved method for coating floss segments is provided. The floss segments may each be disposed in a flossing device. Each flossing device may include the mentioned floss segment (which may be referred to herein as a “floss portion”), which may typically involve floss tape or string floss, and a rigid mount.

The rigid mount may include a first side and a second side. Each of the floss segments may include a first end and a second end. The first and second ends may be fixedly attached to the rigid mount. The first and second ends may be tautly attached to the rigid mount. Such attachment may be obtained by over-molding the floss material on the floss segment. The floss segment may form a floss bridge between the first and second sides of the rigid mount. The floss segment may form a floss bridge between a first and second end of the rigid mount.

As used herein, the terms “flossing device”, “floss pick” and “flosser” all interchangeably refer to a handheld device designed to facilitate flossing. A floss segment may be stretched or tautly suspended on a rigid mount. When held in the hand of a user, the rigid mount may enable interdental introduction of the floss segment, without requiring a high degree of dexterity.

The method may include fixedly arranging the floss segments in an array. The method may include fixedly overlaying the array with a container. The container may include surrounding side walls and a lower wall. The container may hold a coating composition. The container may contain a coating composition. The container may have an open top. The coating composition may be formulated to coat a floss segment.

As used herein, the term “coating composition” may include any composition containing one or more substances intended for coating onto a floss segment. The coating composition may be a fluid composition. The coating composition may be a liquid composition. The coating composition may be a solution. The coating composition may be a suspension. The coating composition may be a partial solution and partial suspension. The coating composition may have a first component that is dissolved and second component that is suspended.

As used herein, the term “wall” or “membrane” in the context of a container is intended to include any face or boundary on a side or bottom of a container, whether rigid or flexible.

The mentioned lower wall may include perforations or slits. The perforations may be configured to align with the floss segments in the array. The perforations may be covered with an encumbrance. The perforations may be covered with a barrier. The encumbrance or barrier may be configured to prevent egress of the coating composition through the apertures at ambient pressure.

The method may include applying downward pressure across all or a portion of the surface of the lower wall. The method may include applying downward pressure across a horizontal cross section of the lower wall. The downward pressure may cause the coating composition to ooze or otherwise exit the container via the perforations. The coating composition may thus contact preferably the top side of the floss segments in the array—i.e., the portion of the floss segments in the array that face the perforation.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1A shows an illustrative partially populated array of flossing devices in accordance with the principles of the described embodiments.

FIG. 1B shows an illustrative fully populated array of flossing devices in accordance with the principles of the described embodiments.

FIG. 2 shows an illustrative perspective view of a coating composition container in accordance with the principles of the described embodiments.

FIG. 3A shows an illustrative top view of a lower wall of a coating composition container in accordance with the principles of the described embodiments.

FIG. 3B shows a magnified view of an aperture in the lower wall.

FIG. 4A shows an illustrative view of a coating composition container positioned above an array of flossing devices in accordance with the principles of the described embodiments.

FIG. 4B shows an illustrative view of a coating composition container overlaid on an array of flossing devices in accordance with the principles of the described embodiments.

FIG. 5A shows an illustrative perspective view of a flat-edge pressure applicator device exerting a downward pressure on a first end of a lower wall of a coating solution container, in accordance with the principles of the described embodiments.

FIG. 5B shows an illustrative perspective view of a flat-edge pressure applicator device exerting a downward pressure on a middle section of a lower wall of a coating solution container, in accordance with the principles of the described embodiments.

FIG. 5C shows an illustrative perspective view of a flat-edge pressure applicator device exerting a downward pressure on a second end of a lower wall of a coating solution container, in accordance with the principles of the described embodiments.

FIG. 6 is a flow diagram depicting a method for coating a plurality of flossing segments in accordance with the principles of the described embodiments.

### DETAILED DESCRIPTION

A method in accordance with the principles of the described embodiments may facilitate applying a coating to a floss segment of a flossing device.

As such, aspects of the present disclosure provide a technical solution to a technical problem of reproducibly and evenly applying a coating to a floss segment of a flossing device, for example in a mass production process.

An improved method for coating floss segments is provided. The floss segments may each be disposed in a flossing device. The floss segments may correspond to floss portions of a flossing device. Each flossing device may include the mentioned floss portion and a rigid mount. Each of the floss segments may include a first end and a second end. The first and second ends may be fixedly attached to the rigid mount. The first and second ends may be tautly attached to the rigid mount. The floss segment may form a floss bridge between a first and second end of the rigid mount.

In some embodiments, the herein-mentioned methods may be automated.

The method may include fixedly arranging the floss segments in an array. The array may have a set, known, and/or predetermined arrangement. Use of a set arrangement may enable repeated use of a given container, since perforations in the lower wall of the container (described hereinbelow), will reproducibly align with the floss segments in the array. The array may be substantially rectangularly shaped. The term “rectangular[ly]”, as used herein, is not intended to exclude a square shape.

The array may include rows or any other suitable arrangement. In some embodiments, the array may include 2-8 rows. The array may include 4-6 rows. Each row may include 6-20 devices. Each row may include 6-20 devices. Each row may include 8-15 devices. Each row may include 8-12 devices.

Before fixedly arranging the floss segments in an array, the described method may include a prior step of inserting a floss segment into each flossing device. In some embodiments, the method may include a prior step of heating and/or stretching the floss segment. The floss segment may be thereby straightened.

The method may include fixedly overlaying the array with a container. The container may include side walls, a lower wall, and a coating composition disposed in the container. The upper and lower walls may be pliable. The upper and lower walls may be rigid. The coating composition may be configured to coat a floss segment. The container may lack an upper wall.

As used herein, the term “wall” in the context of a container is intended to include any face or boundary side of a container, whether rigid or flexible. The side and lower wall (and possibly the side walls) may be formed from a membrane. The side and lower walls may be generally leakproof at ambient pressure.

The mentioned lower wall may include apertures or perforations. The apertures or perforations may be configured to align with the floss segments in the array. The apertures or perforations may be slit-shaped. The length of the slits may be approximately the same length as the floss segments.

The length of the slits may be the same length as the length of the floss segments. The length of the slit may be up to 10 greater than the length of the floss segments. It should be noted that any suitable percentage ratio of the length of the slits to the length of the floss segments is within the scope of the current invention. The width of the slits may be 1-5 millimeters (mm). The width of the slits may be 2-4 mm.

The apertures or perforations may be covered with an encumbrance. The apertures or perforations may be covered with a barrier. The encumbrances or barriers may be configured to impede egress of the coating composition through the apertures at ambient pressure. The encumbrances or barriers may be configured to allow egress of the coating composition through the apertures at elevated pressure. Elevated pressure, in this context, may refer to pressure of 3 or more times ambient pressure. The viscosity of the composition may range from 65 centipoise (cP) at 21° centigrade, to 3000 cP at 21° centigrade.

The encumbrances or barriers may include a wire mesh, a wire screen, a nylon mesh or any other suitable mesh, other material, or any other suitable impediment for restraining the composition from flowing through the membrane absent pressure. The wire screen or mesh can range from 10 holes per square centimeter up to 150 holes per square centimeter. Most preferably, the screen can include 40 holes per square centimeter.

The method may include applying downward pressure across a horizontal cross section of the lower wall. The downward pressure may cause the coating composition to ooze or otherwise exit the container via the apertures or perforations. The coating composition may thus contact the floss segments in the array.

The method may include subsequently removing the container from above the array. The container may be configured for use with another array of flossing devices.

The method may include drying the floss segments following application of the coating composition. Drying the floss segments may include exposure to ambient air. In some embodiments, drying ovens may be used to dry the coating composition.

In some embodiments, the mentioned array may be disposed in a first rigid frame. The first frame may be substantially rectangularly shaped. In some embodiments, the container (that holds the coating composition) may be disposed in a second rigid frame. The second frame may be substantially rectangularly shaped.

In some embodiments, the first frame may include a guardrail. In some embodiments, the first frame may include a plurality of guardrails. In some embodiments, the first frame may be fully or partially framed by a plurality of guardrails. The guardrails may be configured to mate with the second frame. The guardrails may be configured to fit snugly around the second frame. The guardrails may be configured to fit into grooves contained within the second frame. Connecting the first and second frames together may serve to anchor the first and second frames to one another. In some embodiments, the first frame may comprise a plurality of aligning projections. In some embodiments, the aligning projections may be configured to fit into complementary grooves or openings in the second frame.

Reference herein to anchoring the first and second frames to one another may include embodiments wherein either the first or second frame is already anchored to a stationary component of the system, prior to anchoring the frames to one another. A stationary component may include a floor-mounted component or a component that is not readily moved, for example a heavy piece of equipment.

In some embodiments, the second frame may include a guardrail. In some embodiments, the second frame may include a plurality of guardrails. In some embodiments, the second frame may be fully or partially framed by a plurality of guardrails. The guardrails may be configured to mate with the first frame. The guardrails may be configured to fit snugly around the first frame. The guardrails may be configured to fit into grooves contained within the first frame. Connecting the first and second frames together may serve to anchor the first and second frames to one another. In some embodiments, the second frame may comprise a plurality of aligning projections. In some embodiments, the aligning projections may be configured to fit into complementary grooves or openings in the first frame.

In some embodiments of the method, the downward pressure may be applied via a pressure applicator. The pressure applicator may be rigid. The pressure applicator may have a flat lower edge. The lower edge may be rigid. The lower edge may have the shape of a straight, flat strip of material. The length of the lower edge may substantially correspond to one dimension of the array. The length of the lower edge may substantially correspond to one dimension of a rigid frame used to house the array. In some embodiments, the pressure application may be non-rigid.

The pressure applicator may be configured to be swept across the array. The pressure applicator may be configured to press on the upper side of the lower wall of the container. The pressure applicator may be configured to be pressed in a sweeping motion across the lower wall of the container. The pressure applicator may be configured to be dragged across the lower wall of the container. The pressure applicator may be initially aligned at a first edge of the array, the first edge forming a first axis. The lower edge may span, or stretch across, a first dimension of the array. The lower edge may be configured to sweep the pressure applicator across the dimension of the array perpendicular to the first axis. The described method may include sweeping the pressure applicator across the dimension of the array perpendicular to the first axis.

In some embodiments of the method, the downward pressure may be applied via a rotatable cylinder. The cylinder may be initially aligned at a first edge of the array, the first edge forming a first axis. The cylinder may be configured to roll across the array. The cylinder may be configured to roll across the dimension of the array perpendicular to the mentioned first axis. The described method may include rolling the cylinder across the dimension of the array perpendicular to the first axis. The cylinder may have a longitudinal axis. The longitudinal axis may span a first dimension of the array. The axis may sweep across a second dimension of the array. The second dimension may be perpendicular to the first dimension.

The mentioned coating composition may, in some embodiments, include a flavoring ingredient. In some embodiments, the coating composition may include a wax. In some embodiments, the coating composition may include a flavoring ingredient and a wax.

In some embodiments, there is provided herein a system for coating a plurality of floss segments. Each of the floss segments may be located in a flossing device. Each floss segment may be a component of a flossing device.

Each flossing device may include a floss segment and a rigid mount. Each of the floss segments may include a first end and a second end. The first and second ends may be fixedly attached to the rigid mount. The first and second ends may be tautly attached to the rigid mount. The first and second ends may form a floss bridge between the first end and the second end. The first and second ends may form a floss bridge between a first end and a second end of the rigid mount.

The mentioned system may include a first frame. The first frame may be configured to fixedly arrange the floss segments in an array.

The system may include a container. The container may be configured to fixedly overlay the array.

The container may include side walls.

The container may include a lower wall or membrane. The side walls and lower wall or membrane may together form a space or volume capable of holding a liquid composition.

The container may hold a coating composition. The coating composition may be disposed in the mentioned space or volume.

The mentioned lower wall or membrane may include apertures or perforations. The apertures or perforations may be spaced to align with the floss segments in the array. The apertures or perforations may be configured to align with the floss segments in the array.

The apertures or perforations may be each covered with an encumbrance. The apertures or perforations may be each covered with a barrier. The encumbrances or barriers may include a wire mesh. The encumbrances or barriers may be configured to impede egress of the coating composition through the apertures at ambient pressure.

The system may include a rigid pressure applicator. The pressure applicator may be configured to apply downward pressure across a horizontal cross section of the lower wall of the container. The system may include a rotatable cylinder.

The pressure applicator may be configured to sweep across the array. The pressure applicator may be configured to press on the lower wall of the container. The pressure applicator may be configured to be dragged across the lower wall of the container. The pressure applicator may be initially aligned at a first edge of the array, the first edge forming a first axis. The lower edge may span, or fit across, a first dimension of the array. The lower edge may be configured to sweep the pressure applicator across the dimension of the array perpendicular to the first axis. The described method may include sweeping the pressure applicator across the dimension of the array perpendicular to the first axis.

In some embodiments, the downward pressure may be applied via a rotatable cylinder.

In some embodiments, there is provided herein a system for coating floss segments. The floss segments may each be disposed in a flossing device. The flossing devices may include the floss segments and a rigid mount. The rigid mount may have a first side and a second side. The floss segments may each have a first end and a second end. The first and second ends may be fixedly attached to first and second sides, respectively, of the rigid mount.

The system may include a first frame configured to fixedly arrange the floss devices in an array.

The system may include a container configured to fixedly overlay the array. The container may include surrounding side walls and a lower membrane. There may be a coating composition located in the container.

The lower membrane may include apertures. The apertures may be spaced to align with the floss segments in the array.

The apertures may be each covered with an encumbrance. The encumbrances may be configured to hold the coating composition in the container at ambient pressure.

The system may include a rigid pressure applicator. The rigid pressure applicator may be configured to apply downward pressure on the lower wall.

The mentioned first frame may include a plurality of recesses. The mentioned first frame may include a plurality of surface cavities. The mentioned first frame may include a plurality of undercuts. The recesses, cavities, or undercuts may be configured to immobilize the flossing devices. The devices may be immobilized in a preset array pattern.

In some embodiments, the first frame may be a rigid frame.

In some embodiments, the mentioned container may be disposed in a second rigid frame. The container may be fixedly connected to a second rigid frame.

In some embodiments, the first frame may include a plurality of guardrails. The guardrails may be configured to mate with the second frame. The guardrails may be configured to anchor the first and second rigid frames to one another.

In some embodiments, the second frame may include a plurality of guardrails. The guardrails may be configured to mate with the first frame. The guardrails may be configured to anchor the first and second frames to one another.

In some embodiments, the rigid pressure applicator may include a lower edge. The lower edge spans a first dimension of the array and sweeps across a second dimension of the array. The lower edge may span a first dimension of the array. The lower edge may fit across a first dimension of the array.

In some embodiments, the rigid pressure applicator may be a rotating cylinder.

In some embodiments, the coating composition may include a flavor ingredient. In some embodiments, the coating composition may include wax. In some embodiments, the coating composition may include both a flavor ingredient and a wax.

System, apparatus and methods described herein are illustrative.

System, apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional, and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

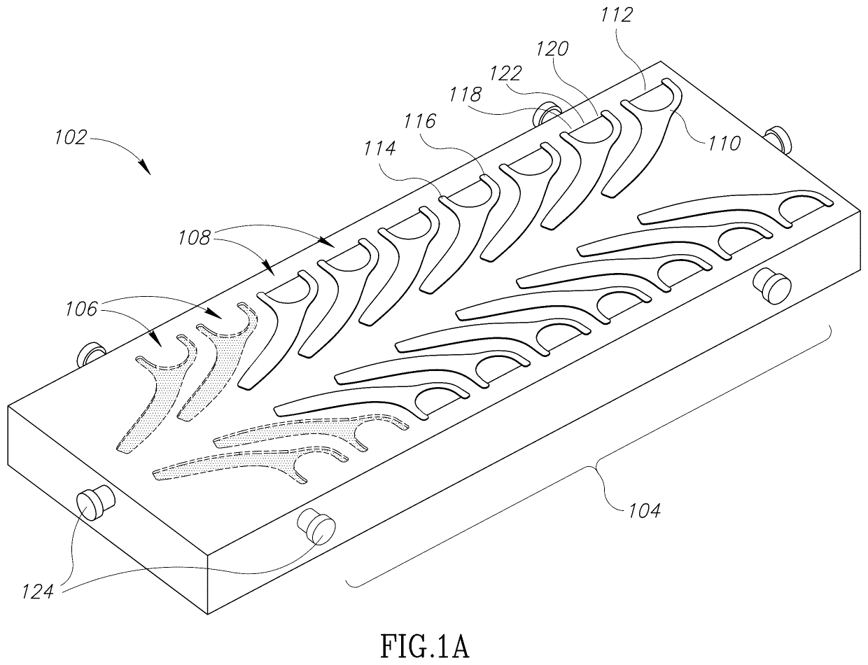

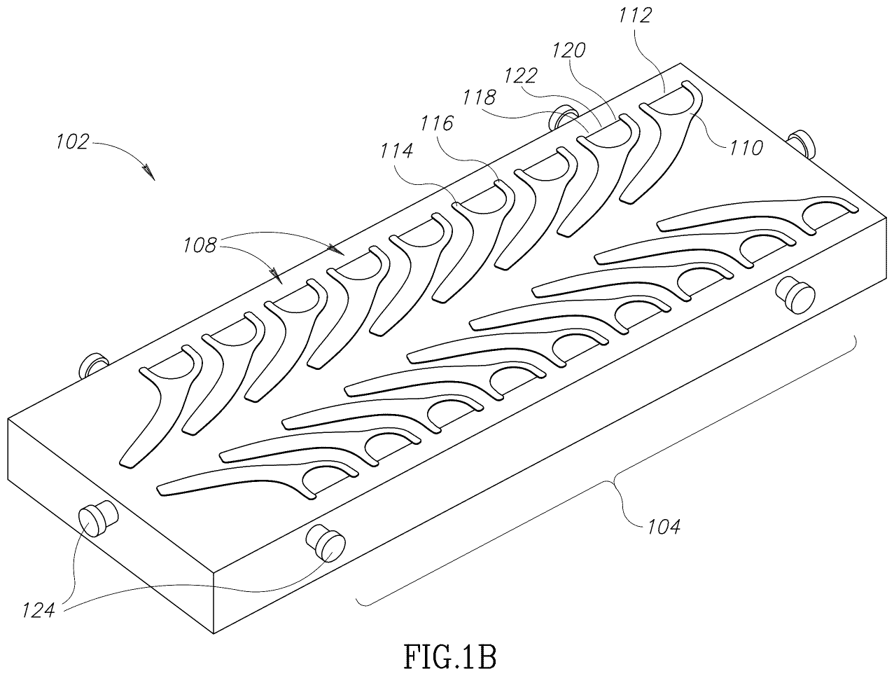

FIG. 1A provides a diagram of a frame 102 configured to fixedly arrange a plurality of floss segments in an array, in accordance with the principles of the described embodiments. Frame 102 may house an array 104, which may have a fixed pattern of recesses 106. Recesses 106 (which also may be referred to as “surface cavities”) are configured to be populated by flossing devices 108, flossing devices 108 including a rigid mount 110 and a floss segment 112. Each rigid mount may include a first side 114 and a second side 116. As depicted, recesses 106 are partially populated by flossing devices 108.

Each floss segment 112 may include a first end 118 and a second end 120. First end 118 and second end 120 may be fixedly attached to rigid mount 110 to form a floss bridge 122 between first side 114 and second side 116.

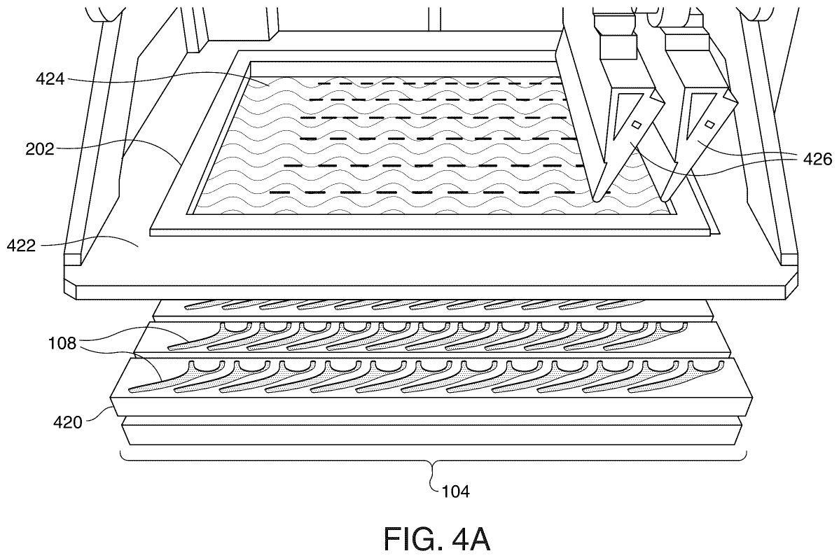

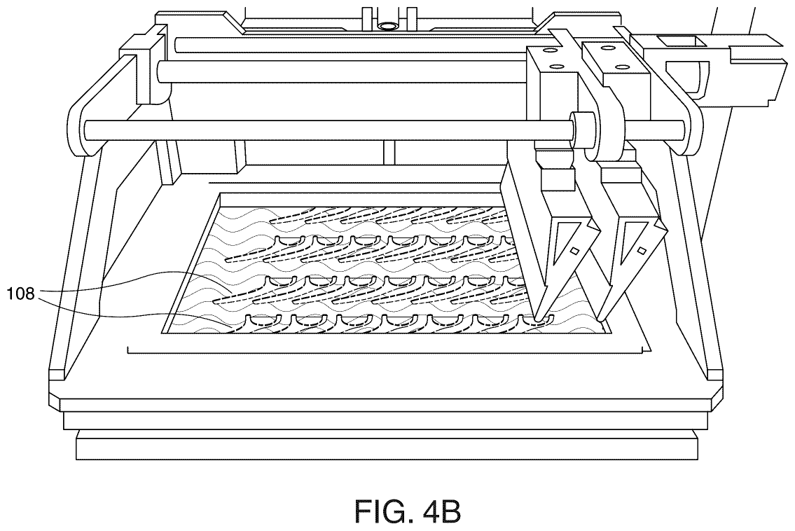

Frame 102 may include a plurality of aligning projections 124. Aligning projections 124 may be configured to mate with a second frame (an embodiment of a second frame is depicted in FIG. 4).

FIG. 1B shows an illustrative array of flossing devices in accordance with the principles of the described embodiments. Components are the same as FIG. 1A, with a difference being that array 104 in FIG. 1A is partially populated, while array 104 in FIG. 1B is fully populated.

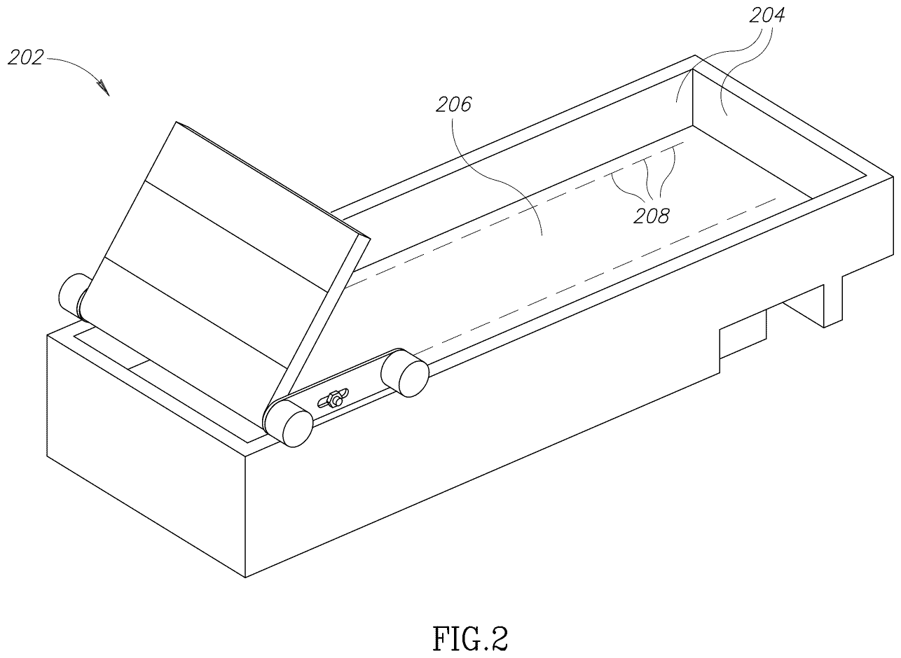

FIG. 2 shows an illustrative perspective view of a coating composition container 202 in accordance with the principles of the described embodiments. Container 202 may include surrounding side walls 204 and a lower wall or membrane 206. The container may hold a coating composition (not depicted in this figure). The coating composition may be held by, or otherwise disposed in, the container. Lower wall or membrane 206 may include apertures 208. Apertures 208 may be spaced to align with the aforementioned arrayed floss segments.

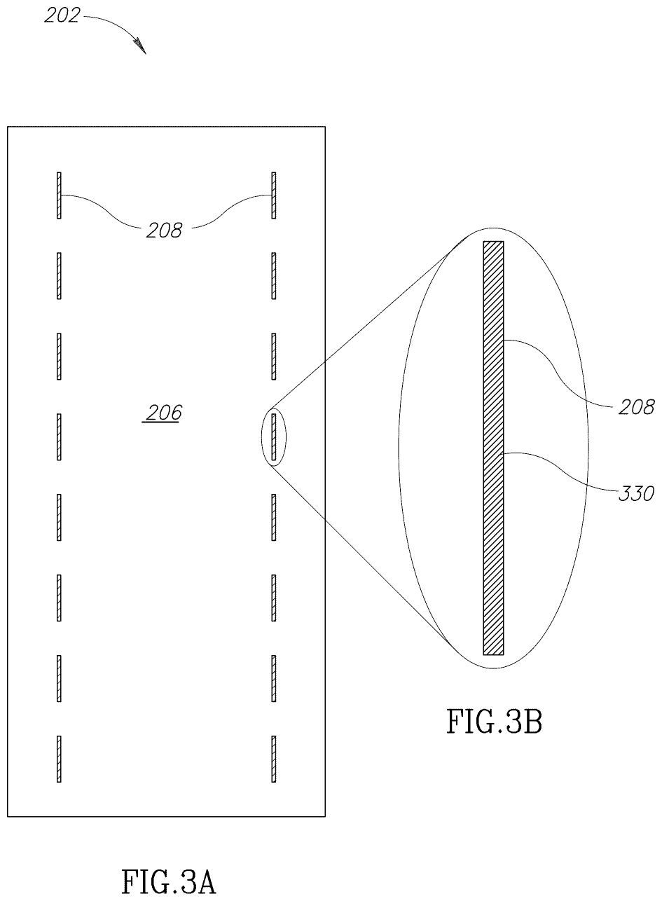

FIG. 3A shows an illustrative top view of a lower wall 206 of a coating composition container 202 in accordance with the principles of the described embodiments, including apertures 208. Apertures 208 may be spaced to align with floss segments in an array. FIG. 3B shows a magnified view of an aperture 208, covered by encumbrance 330. Encumbrance 330 may be encumbrance configured to impede egress of a coating composition through apertures 208 at ambient pressure.

FIG. 4A shows an illustrative view of a coating composition container 202 positioned above an array 104 of flossing devices 108 in accordance with the principles of the described embodiments. Array 104 may be held is a first frame 420. Container 202 may be fixedly attached to a second frame 422. Container 202 may hold a coating composition 424. Lower wall 206, containing apertures 208, may be submerged by coating composition 424. Rigid pressure applicators 426 may be spaced apart from lower wall or membrane 206.

FIG. 4B shows an illustrative view of a coating composition container overlaid on an array of flossing devices in accordance with the principles of the described embodiments. Components are the same as FIG. 4A, with a difference being that coating composition container 202 and second frame 422 have been lowered onto first frame 420. Flossing devices 108 are covered with lower wall or membrane 206 and coating composition 424. Rigid pressure applicators 426 may remain spaced apart from lower wall or membrane 206.

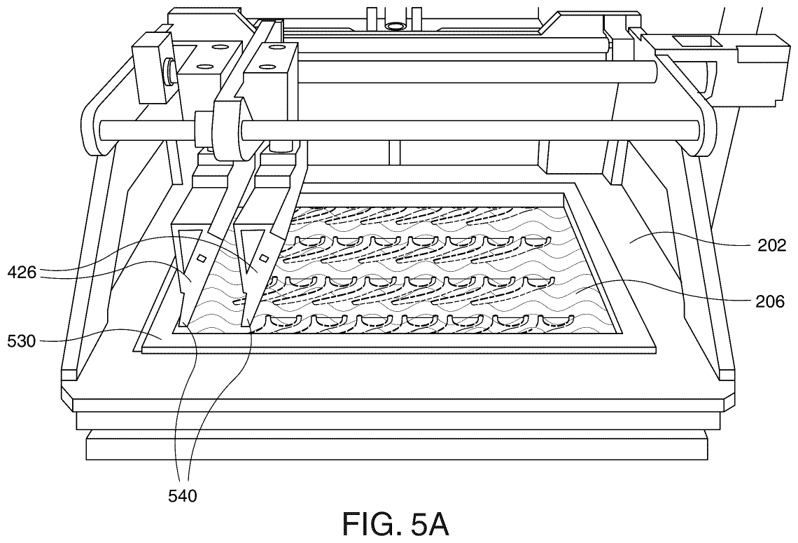

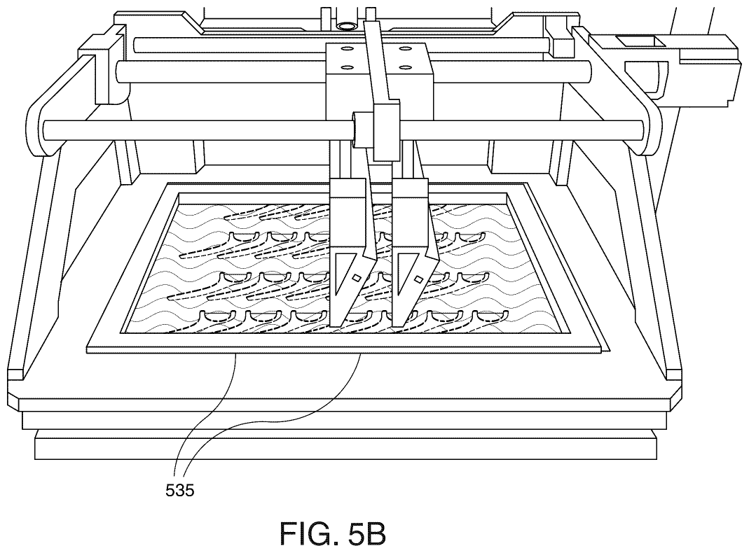

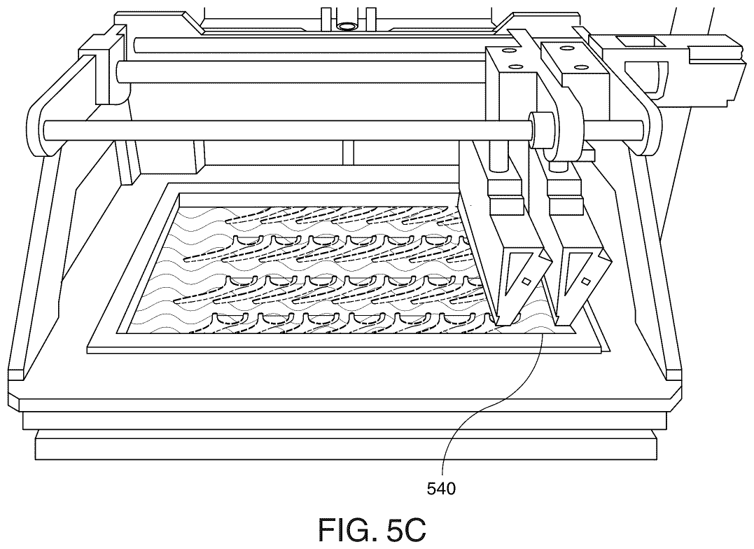

FIG. 5A shows an illustrative perspective view of a flat-edge rigid pressure applicator devices 426 exerting a downward pressure on a first end 530 of a lower wall or membrane 206 of a coating solution container 202, in accordance with the principles of the described embodiments. Flat lower edges 540 of applicator devices 426 have been lowered to touch lower wall 206 and are positioned to sweep across lower wall or membrane 206.

FIG. 5B shows an illustrative perspective view of a flat-edge pressure applicator device exerting a downward pressure on a middle section 535 of a lower wall of a coating solution container, in accordance with the principles of the described embodiments. Applicator devices 426 are in the process of sweeping across lower wall or membrane 206.

FIG. 5C shows an illustrative perspective view of a flat-edge pressure applicator device exerting a downward pressure on a second end 540 of a lower wall of a coating solution container, in accordance with the principles of the described embodiments. Applicator devices 426 are completing the sweep across lower wall or membrane 206.

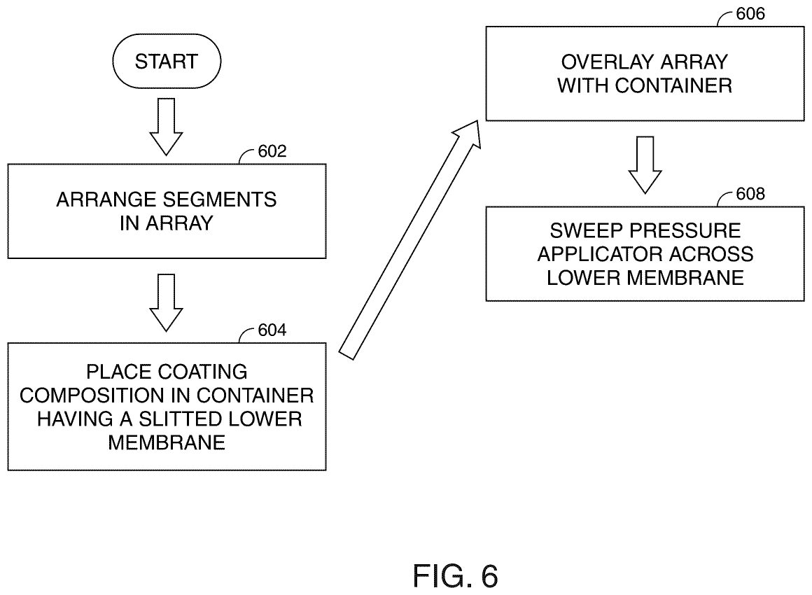

FIG. 6 is a flow diagram depicting a method for coating a plurality of flossing segments in accordance with the principles of the described embodiments. At 602, floss segments may be fixedly arranged in an array. At 604, coating composition may be placed in an open-top container. The container's bottom wall may contain apertures aligned with the floss segment pattern and covered with encumbrances. At 606, the array may be fixedly overlaid with the container that holds the coating composition. At 608, downward pressure may be applied to one end of the lower wall of the container. At 610, a pressure applicator may be swept across the lower wall.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods, systems, apparatus, and products for coating floss segments of flossing device are provided. Persons skilled in the art will appreciate that the present invention can be practiced by other than the described embodiments, which are presented for purposes of illustration rather than of limitation.

What is claimed is:

1. A method for coating a plurality of floss segments, wherein:
each of the floss segments is disposed in a respective flossing device;
each of the flossing devices comprises the floss segment and a rigid mount, the rigid mount comprising a first side and a second side;
each of the plurality of floss segments comprises a first end and a second end; and
the first and second ends are fixedly attached to the rigid mount to form a floss bridge between the first side and the second side,
the method comprising:
fixedly arranging the floss devices in an array;
fixedly overlaying the array with a container, the container comprising surrounding side walls and a lower membrane; and the container holding a coating composition disposed in the container; wherein:
the lower membrane comprises apertures, wherein the apertures are spaced to align with the flossing devices in the array; and wherein the apertures are each covered with an encumbrance, the encumbrance being configured to impede egress of the coating composition through the apertures at ambient pressure;
and
applying downward pressure horizontally across the lower membrane.

2. The method of claim 1, wherein the array is disposed in a first rigid frame.

3. The method of claim 2, wherein the container is fixedly attached to a second rigid frame.

4. The method of claim 3, wherein the first rigid frame comprises a plurality of projections, the projections configured to mate with the second rigid frame and anchor the first and second rigid frames to one another.

5. The method of claim 3, wherein the second rigid frame comprises a plurality of projections, the projections configured to mate with the first rigid frame and anchor the first and second rigid frames to one another.

6. The method of claim 1, wherein the downward pressure is applied via a rigid, pressure applicator that sweeps across the lower membrane.

7. The method of claim 1, wherein the encumbrance is a wire mesh.

8. The method of claim 1, wherein the coating composition comprises a flavoring ingredient.

9. The method of claim 8, wherein the coating composition further comprises wax.

10. The method of claim 1, wherein the coating composition comprises wax.

11. The method of claim 1, wherein the method is automated.

12. A system for coating a plurality of floss segments, wherein:
each of the floss segments is disposed in a flossing device;
the flossing devices each comprise the floss segments and a rigid mount, the rigid mount comprising a first side and a second side;
the plurality of floss segments each comprise a first end and a second end; and
the first end and the second end are fixedly attached to the rigid mount to form a floss bridge between the first side and the second side,
the system comprising:
a first frame configured to fixedly arrange the floss segments in an array;
a container configured to fixedly overlay the array, the container comprising surrounding side walls and a lower wall and containing a coating composition disposed in the container, wherein the lower wall comprises apertures, wherein the apertures are spaced to align with the floss segments in the array; and wherein the apertures are each covered with an encumbrance, the encumbrance being configured to impede egress of the coating composition through the apertures at ambient pressure;
and
a rigid pressure applicator, wherein the rigid pressure applicator is configured to apply downward pressure horizontally across the lower wall.

13. The system of claim 12, wherein the first frame comprises a plurality of surface cavities, the cavities being configured to immobilize the flossing devices.

14. The system of claim 12, wherein the container is fixedly attached to a second frame.

15. The system of claim 14, wherein the first frame comprises a plurality of projections, the projections configured to mate with the second frame and anchor the first and second frames to one another.

16. The system of claim 14, wherein the second rigid frame comprises a plurality of projections, the projections configured to mate with the first frame and anchor the first and second frames to one another.

17. The system of claim 12, wherein the rigid pressure applicator has a flat lower edge, wherein the lower edge is configured to sweep across the array.

18. The system of claim 12, wherein the encumbrance is a wire mesh.

19. The system of claim 12, wherein the coating composition comprises a flavoring ingredient.

20. The system of claim 19, wherein the coating composition further comprises wax.

21. The system of claim 12, wherein the coating composition comprises wax.

22. A system for coating floss segments, wherein:
the floss segments are each disposed in a flossing device;
the flossing devices comprise the floss segments and a rigid mount, the rigid mount having a first side and a second side;
the floss segments each have a first end and a second end; and
the first end and the second end are fixedly attached to first side and the second side, respectively, of the rigid mount,
the system comprising:
a first frame configured to fixedly arrange the floss segments in an array;
a container configured to fixedly overlay the array, the container comprising surrounding side walls and a lower membrane, wherein:
a coating composition is disposed in the container;
the lower membrane comprises apertures, wherein the apertures are spaced to align with the floss segments in the array; and
the apertures are each covered with an encumbrance, the encumbrance being configured to hold the coating composition in the container at ambient pressure;
and
a rigid pressure applicator, wherein the rigid pressure applicator is configured to apply downward pressure on the lower membrane.

23. The system of claim 22, wherein the first frame comprises a plurality of surface cavities, the cavities being configured to immobilize the flossing devices.

24. The system of claim 22, wherein the container is fixedly attached to a second frame.

25. The system of claim 24, wherein the first frame comprises a plurality of projections, the projections configured to mate with the second frame and anchor the first and second frames to one another.

26. The system of claim 24, wherein the second rigid frame comprises a plurality of projections, the projections configured to mate with the first frame and anchor the first and second frames to one another.
